(19) United States
(12) Patent Application Publication
(10) Pub. No.: US 2025/0072675 A1
(43) Pub. Date: Mar. 6, 2025

(54) CLEANING DEVICE AND METHOD FOR USING A CLEANING DEVICE

(71) Applicant: Lissowski Gebäudereinigung GmbH, Aachen (DE)

(72) Inventors: Sascha LUDWIGS, Aachen (DE); Uwe BOEHME, Aachen (DE)

(73) Assignee: Lissowski Gebäudereinigung GmbH, Aachen (DE)

(21) Appl. No.: 18/721,955

(22) PCT Filed: Dec. 16, 2022
(86) PCT No.: PCT/DE2022/000122

§ 371 Date: Jun. 20, 2024

(30) Foreign Application Priority Data
Dec. 20, 2021 (DE) 10 2021 006 264.7
Mar. 23, 2022 (DE) 10 2022 001 005.4
Jul. 11, 2022 (DE) 10 2022 002 507.8
Aug. 4, 2022 (DE) 10 2022 002 835.2

(51) Int. Cl. A47L 1/02; A46B 13/04; B64U 10/13; B64U 101/29

(52) U.S. Cl. CPC A47L 1/02; A46B 13/04; B64U 10/13; A46B 2200/3073; B64U 2101/29

(57) ABSTRACT

A cleaning device includes a support, a drive, a holder and cleaning elements. The holder has a longitudinal axis, on which the cleaning elements are arranged so as to be displaceable with the drive relative to the support. According to the method, the cleaning elements can be moved in opposite directions on the longitudinal axis or on axes which are arranged in parallel to one another.

The invention relates to a cleaning device comprising a carrier, a drive, a holder, and cleaning elements.

Sponges, brushes, and more complex equipment are known for cleaning objects and surfaces. In addition, different cleaning devices comprising a drive are known, which generally moves brushes in a rotational manner in order to clean surfaces and in order to remove dirt, which then loosens from the brush again by means of the centrifugal force, from the surface.

The invention relates in particular to cleaning devices for cleaning flat surfaces, such as in particular of glass panes or facade surfaces. The problem that not only the flat surface but also a structured frame should usually be cleaned results in particular in the case of facade surfaces. This creates increased demands on the formation of the cleaning device.

The cleaning devices according to the invention can serve for the manual use, they can be set up on the floor, and can be moved via mechanisms. However, the cleaning device can also be fastened to a flying object. It is particularly important for all applications that the cleaning device is manufactured to be as light as possible in order to facilitate the positioning thereof on the surface to be cleaned.

Based on the known prior art, the invention is based on the object of further developing a generic cleaning device.

This object is solved by means of a cleaning device comprising the features of patent claim 1. The independent method claim describes an advantageous use of a cleaning device. Advantageous further developments are subject matter of the subclaims.

The cleaning device according to the invention allows the displacement of cleaning elements on a longitudinal axis by means of a drive. The use of several cleaning elements provides for a modular setup, the exchange of cleaning elements, and the simultaneous use of the cleaning elements. The displaceability relative to the carrier provides for a wiping, brushing, or rubbing on the surface to be cleaned, wherein the cleaning elements can also take over different cleaning functions. The longitudinal axis of the holder can be defined by means of struts, relative to which the cleaning elements can be moved by means of the drive.

The cleaning elements are thus not only rotatable about an axis, for example as rotating brush, but they can furthermore also be displaceable relative to the carrier, and thirdly, they can also be movable relative to the surface to be cleaned together with the carrier. In many cases, it is sufficient when the cleaning elements are only displaceable relative to the carrier and are movable with the carrier.

As carrier, the cleaning device can have, for example, guides, by means of which the cleaning elements are laterally displaceable relative to the surface to be cleaned. However, the cleaning elements can also be displaceable relative to the holder of the cleaning device and can even also move themselves, that is rotate, pivot, or move back and forth, for example.

It is advantageous when the cleaning elements are displaceable with the carrier in one direction and are displaceable relative to the carrier in a direction orthogonally thereto. The carrier can then move the cleaning elements up and down, for example, while the cleaning elements are moved back and forth transversely thereto. It can additionally be provided that the cleaning elements move relative to the carrier and relative to the holder, in order to brush, or to wipe, or to spray, for example, as rotating cleaning element or pivotable cleaning element at the location of the contact between the cleaning element and the surface to be cleaned.

Guides, as they are known from blinds or roller shutters, are suitable as carriers, and guides that are already available, can also be used as carriers. The advantage of a two-sided guidance of the holder is that the cleaning elements can always be arranged on the holder so that it is balanced in a horizontal direction, and thus no or only very small torsional forces act on the carrier in particular in a direction transversely to the longitudinal extension of the carrier.

The cleaning device can also be constructed to be so light that a copter and in particular a multi-copter, a rotary wing drone, or another flying apparatus can be used as carrier. The flying apparatus, such as in particular a copter, makes it possible to move the cleaning device on surfaces, which could not be reached otherwise without complex devices. In particular in the case of facades, the facade surfaces, such as in particular the windows in the upper region of buildings, are often difficult to reach, and a copter is thus proposed as carrier, which carries the cleaning elements and the drive and positions them relative to the surface to be cleaned.

A simple way for moving the cleaning elements individually or also several cleaning elements jointly, is that the drive has a belt. The belt can connect one or several drives to one or several cleaning elements, in order to convert the force of the drive into a preferably linear movement of the cleaning elements. A toothed rack, a chain, a linear motor, or a spindle, for example, can also be used instead of a belt.

To fasten the cleaning elements to the holder, it is advantageous when the holder has a rod assembly. The rod assembly can thereby have several parallel rods, on which the cleaning elements are arranged. When the rods of the holder are aligned parallel to the longitudinal axis of the holder, this enables a movement of the cleaning elements relative to the carrier along the parallel rods by means of the drive.

The cleaning elements can slide along the rods and they can be moved in a direction of a longitudinal axis even without rods. It is advantageous, however, when the cleaning elements are arranged on the rods by means of rollers, so that they can be moved as easily as possible relative to the rods.

A balanced mode of operation is made easier in that the longitudinal axis of the holder extends on both sides of the carrier. This makes it easier to arrange cleaning elements on both sides of the carrier. It is particularly advantageous when the cleaning elements are displaceably arranged on the holder so that they can be moved from one side of the carrier to the other side thereof. A standardized carrier is advantageous, which carries the cleaning elements, and a linear guide. The cleaning elements are preferably fixedly mounted on the standardized carrier but are movably arranged via the linear guide.

The cleaning elements can thus preferably not only be moved on the right and on the left of the carrier but can also be moved past the carrier from one side to the other side. This makes it possible to simultaneously clean a larger surface, without creating streaks in the transition regions between surfaces to be cleaned. In addition, care can be taken that the same number of cleaning elements is generally arranged on the right and on the left of the carrier even during the use of the cleaning device. The cleaning elements can preferably be flexibly arranged on a standardized carrier. The carrier, which can consist of several and preferably of two carrier elements, can be received in a linear guide system and can be moved there. The movement of the carriers with fitted cleaning elements then always takes place from a stop of a vertical window cover profile to the stop on the other side of the vertical window cover profile. This means that in the case of a preferred embodiment, the cleaning elements are moved horizontally on a carrier, and the carrier preferably also has horizontal struts, which can be moved vertically to the struts.

It is advantageous thereby when the holder has a width in the direction of its longitudinal axis, which is greater than 1 m. It is advantageous when the width of the holder is greater than 1.3 m and preferably even when the holder is more than 1.5 m wide. Transversely to its width, the holder can have an extension as height of more than 50 cm, so that several cleaning elements can be arranged one on top of the other in the direction of the height and can also be displaced parallel to one another.

The cleaning elements can be liquid or gas nozzles, they can be formed as wipers comprising sealing lips or as polishing cushion surfaces, and at least some of cleaning elements preferably have a brush. Two or several spiral brushes, for example, can be provided as brushes. These brushes, which are preferably mounted and driven in a rotational manner, can also be counter-rotated. This brush is preferably not formed as rotating brush, but the brush has a front side with bristles, on which the bristles are not arranged as roller, but as bristle surface. It is important that for reasons of balance, the larger part of the brush or of the bristles should always engage with the surface to be cleaned, if possible. It is not important thereby whether the surface of the brush formed by the bristles is round or flat. The brush preferably also has rollers, by means of which it can be moved relative to the carrier.

To wet the surface to be cleaned with water, distilled water, pure water and/or a cleaning agent, it is proposed that at least one cleaning element of the cleaning device has a cleaning agent dispensing system. A cleaning technology using pure water is advantageous, because cleaning agents could lead to an unwanted foam formation. This cleaning agent dispensing system preferably has a brush or a nozzle, which can be acted on from the rear side and which makes it possible to distribute the cleaning agent as extensively as possible to the surface to be cleaned. For the self-cleaning of the brush elements, it is proposed that pure water is applied to them from the rear to the front.

The cleaning water can also simply drain downwards, in particular when demineralized water is used. It is advantageous when the surface to be cleaned is cleaned from the top to the bottom because the cleaning water, which runs down, can wet surfaces, which have not been cleaned yet or can even rinse off dirt.

To save pure water and to allow as little cleaning agent as possible to get into the environment, it is proposed that at least one cleaning element has a cleaning agent receiving system. The cleaning agent receiving system can have a suction system. A suction system of this type can also be formed in such a way that with it, the cleaning device is held at the surface to be cleaned or that with it, the positioning relative to the surface to be cleaned is made easier. The entire cleaning device can thus cling to the surface to be cleaned by means of the suction system, or only a positioning of the cleaning device relative to the surface to be cleaned can also be made easier by means of the suction system. The suction effect of the suction system is preferably 50 to 100 mbar, which leads to a corresponding contact pressure.

The carrier and in particular the copter can be positioned and moved by means of different energy carriers. An energy carrier is also required for the drive for the movement of the cleaning elements. It is thus proposed that the carrier has a hydrogen drive, in particular a fuel cell. This makes it possible to supply the necessary energy for the positioning of the cleaning device relative to the surface to be cleaned and/or energy to the drive for moving the cleaning elements.

Due to the fact that a hydrogen drive usually generates water, it is proposed to use at least a portion of this water for the cleaning.

For the use of a cleaning device and in particular of the described cleaning device, it is proposed that the cleaning elements are moved on one axis or axes arranged parallel to one another, preferably in opposite directions. The cleaning device can thereby be positioned, for example, in front of a window pane, and the cleaning elements can be displaced back and forth on a horizontal line, in order to thereby wet the window surface or another surface to be cleaned with cleaning agents and/or to clean it. It is advantageous thereby when the cleaning elements can be moved past one another in a limited region. For example, cleaning elements arranged one on top of the other can be moved in the opposite direction and can also be moved past one another, in order to clean the window so that no vertical streaks remain on a width, which preferably corresponds to the window width.

The cleaning elements can also be displaced jointly transversely to the axis. When this axis is, for example, a horizontal axis, and the cleaning elements are displaced back and forth on this horizontal axis, it is advantageous when the entire cleaning device is moved vertically, in order to be able to use the latter to also clean a pane, which is higher than the cleaning device. It is advantageous thereby when the cleaning device is pushed from top to bottom along the surface to be cleaned, while the cleaning elements are displaced back and forth horizontally. This makes it possible to quickly and easily clean a vertical surface to be cleaned, such as in particular a window or a facade surface, preferably also including the frames.

The subclaims and the description show advantageous features, which are essential for the invention, also independently of the features specified in the independent claims.

Advantageous exemplary embodiments are illustrated in the drawing. These exemplary embodiments only serve to describe the principle, and the invention furthermore extends to different embodiment types, which the person of skill in the art gathers from the description and the patent claims.

The exemplary embodiment shows a cleaning device, which can in particular be used to clean buildings, preferably the glass facades thereof, in particular curtain glass facades. This facade type is characterized by a high glass surface portion, formed from standardized multi-layer glass elements. To hold and seal these glass elements, frame elements are fastened to the building structure. The glass elements are positioned by means of seals and are held in position by means of vertical and horizontal fastening strips and cover strips.

Due to environmental influences and weather, the glass elements as well as fastening strips and cover strips become contaminated. The cleaning device can be used for very different cleaning tasks. A preferred application area is to remove these adhering contaminants from all of the facade parts forming the outer side. The surface, which is to then be cleaned by the cleaning device, is formed from the surface of the glass elements and the surfaces of the vertical and horizontal cover strips. The cleaning device can be designed so that it is possible to clean all of these surfaces and formed edges in one operating step.

For this purpose, the cleaning device can use at least one, preferably at least two driven standardized carrier systems with space for the arrangement of individual or repeatedly combinable cleaning elements. The cleaning elements are preferably brushes or other suitable devices. The drive of the standardized carrier systems allows for a linear and independent movement of the cleaning elements over the surface to be cleaned. The linear movement is preferably performed transversely or at an angle to the direction of movement of the entire device over the facade part to be cleaned.

At least two carrier systems are preferably fitted identically with cleaning elements and are moved linearly over the surfaces to be cleaned in the opposite direction. In the ideal case, this allows for a force balancing of the resulting frictional forces formed from linear drive force and frictional force on the surface. This reduction or, ideally, neutralization of the frictional forces, is advantageous in particular for the guidance of the entire device over the facade—in particular when the entire cleaning device is to be carried by means of a drone, which is driven by means of rotary wings or by means of another flying apparatus. Such flying apparatuses react to introduced forces in a highly sensitive manner and immediately change their planned flight altitude due to these forces.

A cleaning medium is preferably applied to cleaning elements, such as brushes or sponges. The cleaning medium is preferably pure water or distilled water, so that it does not contain any admixtures, which would leave residues on the surface to be cleaned, such as in particular on a glass pane or other elements of a facade, when drying. It is particularly advantageous when the cleaning elements, such as in particular brushes, are rinsed with a sufficient amount of cleaning medium, and all removed contaminants are discharged with this cleaning medium. The person of skill in the art identifies this as a cleaning using pure water. A particular advantage of this mode of operation is that the remaining amount of cleaning agent, which remains on the surface to be cleaned, no longer has any residues, which could cause a contamination of the surface during drying.

The amount of the cleaning agent, which is necessary for the rinsing, can be applied completely via the mechanical cleaning elements, such as brushes or sponges. The rinsing by means of a nozzle is another option. However, said nozzle has to have a high rinsing volume and/or rinsing speed, in order to attain a good effect. The amount of cleaning medium is thus preferably supplied via a brush, so that the bristles of the brush enable a mechanical support during the removal of the contaminants.

It is advantageous when the entire cleaning device is as light as possible. This can be attained in that only little cleaning agent is transported with it. However, is limits the surface to be cleaned. It is thus advantageous when cleaning agent is dispensed in a pulsed manner by means of the cleaning agent dispensing system. The cleaning agent dispensing system can additionally have a tank made of a film material, which is particularly light. This can be attained by means of a tank made of plastic. The film material is preferably made of a film, which is so thin that the tank is not inherently stable and collapses when dispensing cleaning agent. This tank can be held in a frame, which holds the cleaning device. The used structural components are preferably made from hole materials or as strut/truss construction. The finite element analysis makes it easier to minimize the material requirements in order to also reduce the weight.

A preferred exemplary embodiment of a cleaning device according to the invention is illustrated in the drawing and will be described in more detail below, in which

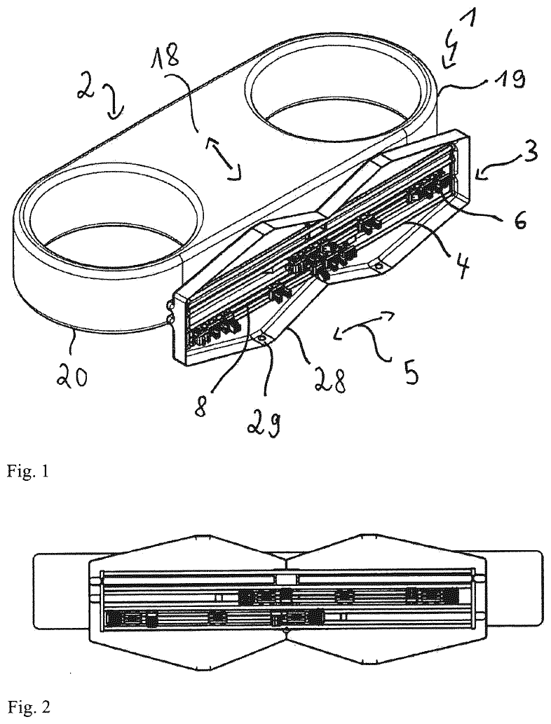

FIG. 1 shows a cleaning device comprising a holder comprising cleaning elements and a copter as carrier,

FIG. 2 shows a side view of the cleaning device shown in FIG. 1,

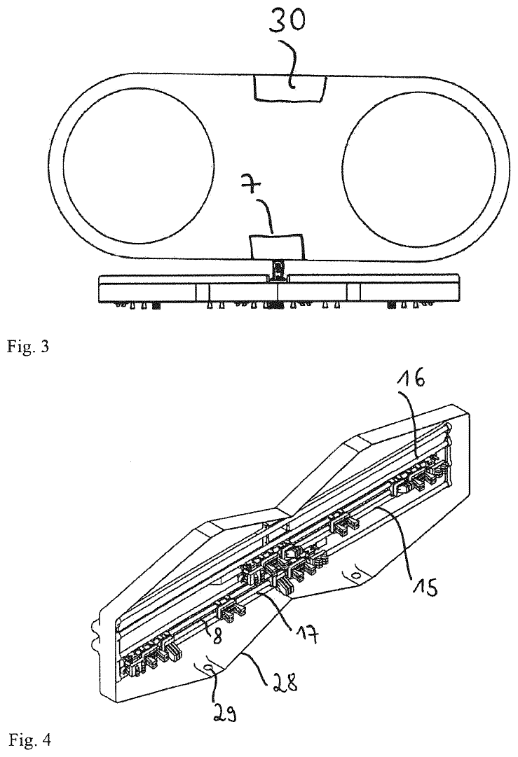

FIG. 3 shows a top view onto the cleaning device shown in FIG. 1,

FIG. 4 shows an enlarged illustration of the holder shown in FIG. 1 comprising the cleaning elements,

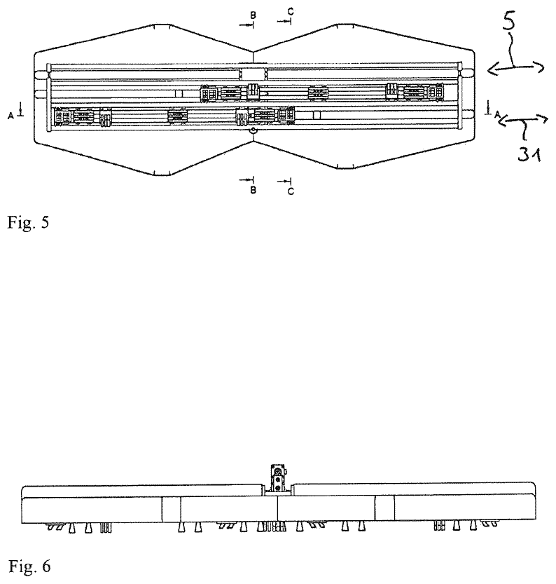

FIG. 5 shows a front view of the holder shown in FIG. 4,

FIG. 6 shows a top view of the holder shown in FIGS. 4 and 5,

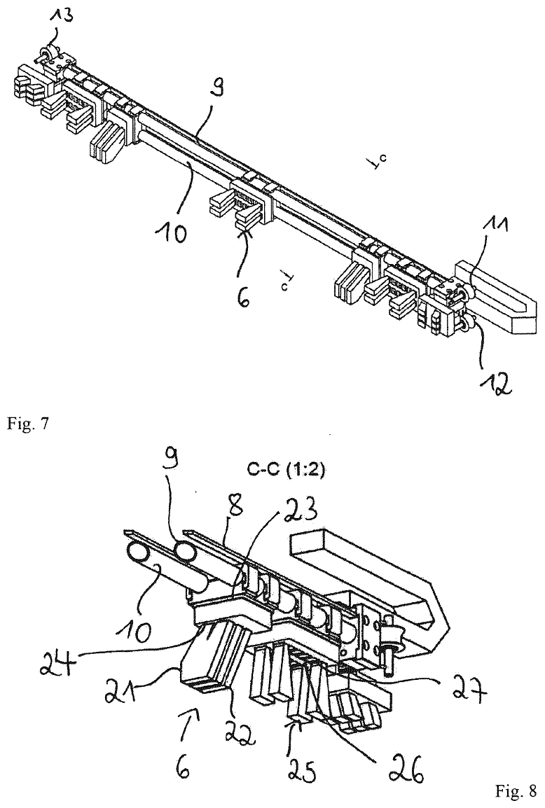

FIG. 7 shows an enlarged view of the holder shown in FIG. 4 comprising the cleaning elements,

FIG. 8 shows an enlarged illustration of the cleaning elements shown in FIG. 7 as section,

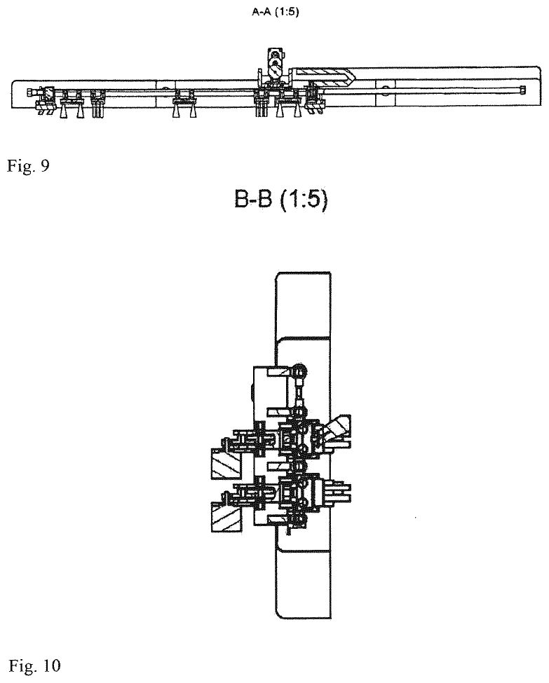

FIG. 9 shows a section along the line AA in FIG. 5,

FIG. 10 shows a section along the line BB in FIG. 5,

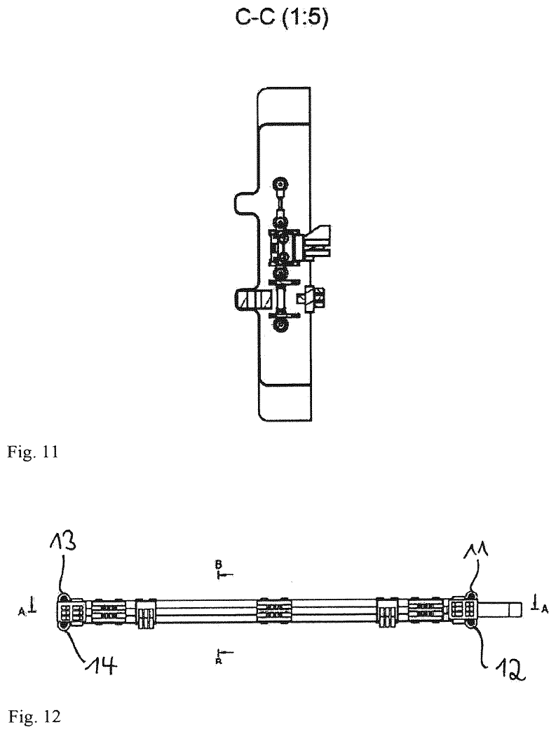

FIG. 11 shows a section along the line CC in FIG. 5,

FIG. 12 shows a side view onto the holder shown in FIG. 7,

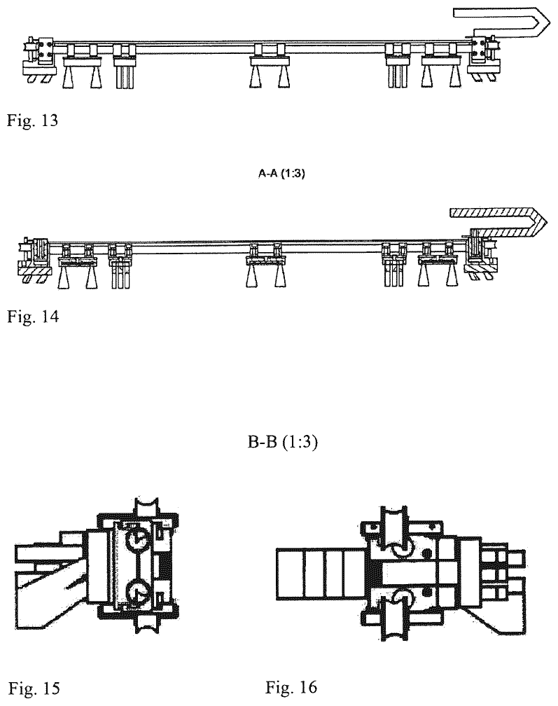

FIG. 13 shows a top view onto the holder shown in FIG. 7,

FIG. 14 shows a section along the line AA in FIG. 12,

FIG. 15 shows a section along the line BB in FIG. 12,

FIG. 16 shows a side view onto the holder shown in FIG. 12 and

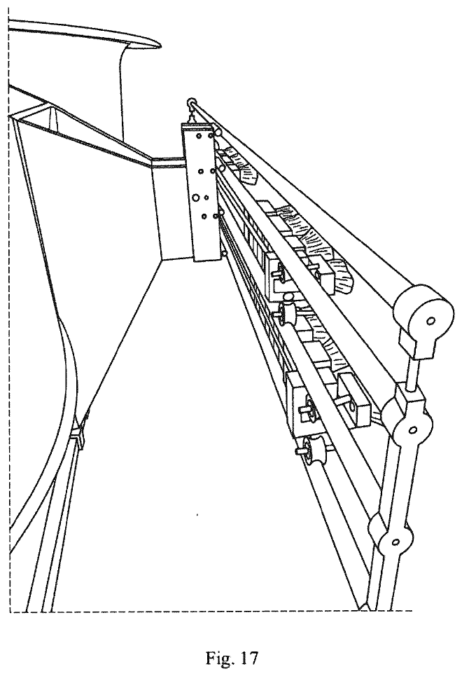

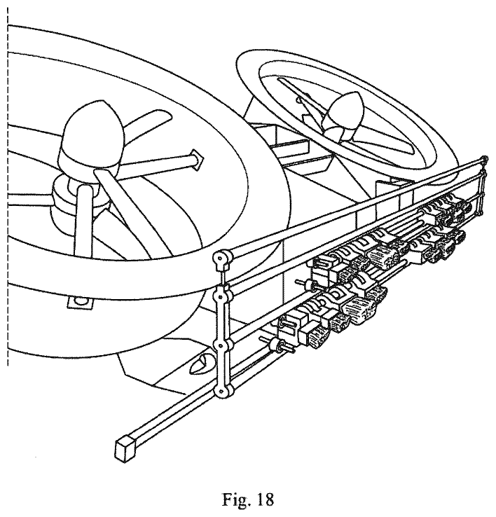

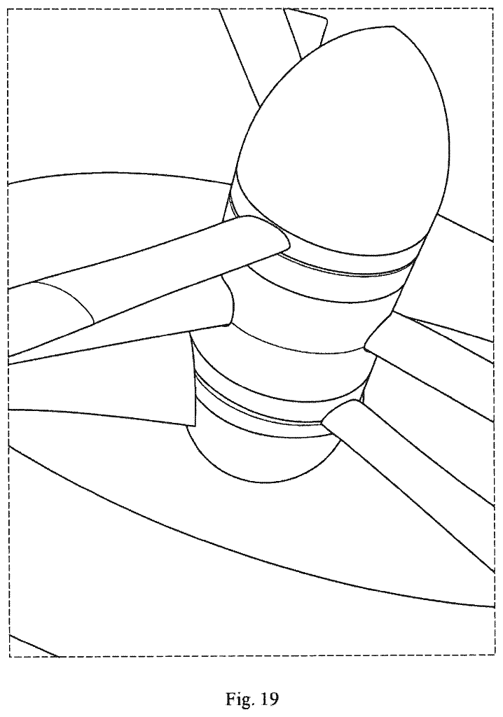

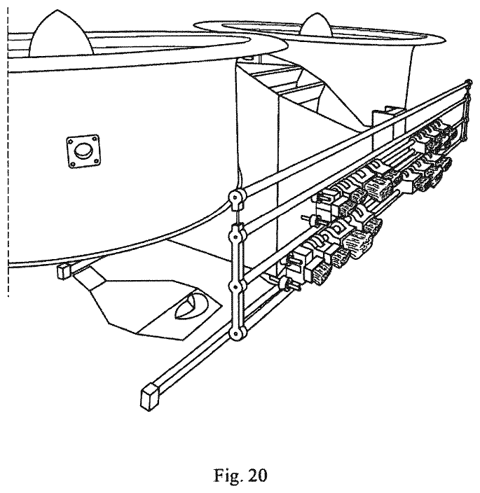

FIGS. 17 to 20 show images of a prototype.

The cleaning device shown in FIG. 1 consists essentially of the carrier 2, which is formed as copter in the present exemplary embodiment, and a holder 3. The carrier 2 formed as copter is only illustrated in a graphically simplified manner without rotors.

The holder 3 has a rod assembly 4, which defines a longitudinal axis 5. Cleaning elements 6 (only numbered in an exemplary manner) are arranged on the rod assembly 4 of the holder 3. A drive 7 makes it possible to displace the cleaning elements 6 along the holder 3 on the longitudinal axis 5 thereof relative to the carrier 2 via a belt 8.

As shown in FIGS. 7 and 8, the rod assembly 4 of the holder 3 has several parallel rods 9 and 10, to which the cleaning elements 6 are fastened. Via rollers 11, 12, 13, and 14, the cleaning elements 6, together with the rods 9, 10, are movably arranged in the direction of the longitudinal axis 5, guided on further parallel rods 15 and 16 or 15 and 17, respectively.

For the weight balancing, the longitudinal axis 5 of the holder 3 extends on both sides of the carrier 2, so that the holder 3 does not exert a torque about an axis 18 on the carrier 2, if possible. The cleaning elements 6 arranged on both sides of the carrier 2 also ensure that the torque about the axis 18 is kept small.

The cleaning elements 6 can be moved towards one another and away from one another again on the holder, so that the weight of the cleaning elements relative to the axis 18 is balanced. Depending on the application, the cleaning elements can also be arranged on the holder so as to be displaceable from one side 19 of the carrier 2 to the other side 20 thereof, wherein care is preferably always taken that the distribution of the cleaning elements on the longitudinal axis 5 is evened out so that the torque acting on the axis 18 is balanced, so that no torsional force about the axis 18 acts on the carrier 2.

FIGS. 7 and 8 also show that a cleaning element 6 can be formed as brush 21 comprising bristles 22. The brush 21 has a rear side 23, with which it is fastened to the rods 9 and 10, and a front side 24, on which the bristles 22 are arranged. The cleaning element 25 arranged next to the cleaning element 6 has a cleaning agent dispensing system 26, which, in turn, has a nozzle 27.

In the present case, the cleaning element 6 or 25 does not have the cleaning agent receiving system, but the holder 3 has a frame 28, which serves as cleaning agent receiving system, because cleaning agent sprayed onto the surface to be cleaned (not shown) by means of the nozzle 27 sprays back to the frame 28 and is guided from the latter to an outlet 29. The outlet 29 is connected to a suction system (not shown) via a hose (not shown).

The carrier 2 has a hydrogen drive 30, which, depending on the application, can also use the cleaning agent, which is guided back via the cleaning agent receiving system 28. In addition, the cleaning agent, which is guided back via the cleaning agent receiving system 28, can also be applied to the surface to be cleaned again via nozzles for pre-cleaning purposes.

So that the cleaning device is kept in balance, if possible, and do not exert any torsional forces on a carrier, the cleaning elements 6 are moved in the opposite direction on the longitudinal axis 5 or on axes 5 and 31, which are arranged parallel to one another. The torque about a central axis 8 exerted by means of the cleaning elements can thus be minimized.

In addition, the cleaning elements 8 can also be moved past one another in a limited region, in order to optimally use the cleaning elements for the cleaning purpose.

To clean larger surfaces, it is advantageous when the cleaning elements 6 are displaced jointly transversely to the axis 5 or the axes 5 and 31 by means of a carrier, such as in particular a guide or a copter.

The images 17 to 20 show a prototype with all functions. Counter-rotating propellers are used here, which are arranged in a cylinder, different brushes are also shown in different colors and the images show the proportions of the individual elements.

1. A cleaning device (1) comprising a carrier (2), a drive (7), a holder (3), and cleaning elements, wherein the holder (3) has a longitudinal axis (5), on which the cleaning elements (6) are displaceably arranged relative to the carrier (2) by means of the drive (7), wherein the cleaning elements (6) can be moved in opposite directions on the longitudinal axis (5) or axes (5, 31) arranged parallel to one another in such a way that a torque exerted by the cleaning elements about a central axis (8) is minimized.

2. The cleaning device according to claim 1, wherein the carrier (2) is a guide.

3. The cleaning device according to claim 1, wherein the carrier (2) is a copter, in particular a multi-copter.

4. The cleaning device according to claim 1, wherein the drive (7) has a belt (8).

5. The cleaning device according to claim 1, wherein the holder (3) has a rodding assembly (4).

6. The cleaning device according to claim 5, wherein the rodding assembly (4) has several parallel rods (9, 10), on which the cleaning elements (6) are arranged.

7. The cleaning device according to claim 6, wherein the cleaning elements (6) are arranged so as to be guided with the rods (9, 10) comprising rollers (11 to 14).

8. The cleaning device according to claim 1, wherein the longitudinal axis (5) of the holder (3) extends on both sides of the carrier (2).

9. The cleaning device according to claim 1, wherein cleaning elements (6) are arranged on both sides of the carrier (2).

10. The cleaning device according to claim 8, wherein cleaning elements (6) are arranged on the holder (3) so as to be displaceable from one side (19) of the carrier (2) to the other side (20) thereof.

11. The cleaning device according to claim 1, wherein at least one cleaning element (6) has a brush (21).

12. The cleaning device according to claim 11, wherein the brush (21) has a front side (24) comprising bristles (22).

13. The cleaning device according to claim 1, wherein at least one cleaning element (6, 25) has a cleaning agent dispensing system (26).

14. The cleaning device according to claim 13, wherein the cleaning agent dispensing system (26) has a nozzle (27).

15. The cleaning device according to claim 1, wherein the holder (3) or at least one cleaning element (6) has a cleaning agent receiving system (28).

16. The cleaning device according to claim 15, wherein the cleaning agent receiving system (28) has a suction system.

17. The cleaning device according to claim 1, wherein the carrier (2) has a hydrogen drive (30), in particular a fuel cell.

18. The cleaning device according to claim 17, wherein the hydrogen drive (3) is connected to the cleaning agent dispensing system (26).

19. A method for using the cleaning device according to claim 1, wherein the cleaning elements (6) are moved in opposite directions on the longitudinal axis (5) or axes (5, 31) arranged parallel to one another.

20. The method according to claim 19, wherein the cleaning elements (6) are moved past one another in a limited region.

21. The method according to claim 19, wherein the cleaning elements (6) are displaced jointly transversely to the axis (5) or the axes (5, 31).
